(19) United States
(12) Patent Application Publication
(10) Pub. No.: US 2004/0047341 A1
(43) Pub. Date: Mar. 11, 2004

(54) Over-the air (ota) service provisioning in a mobile communications system

(76) Inventors: Jens Staack, Helsinki (FI); John Loughney, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/450,298

(22) PCT Filed: Dec. 21, 2000
(86) PCT No.: PCT/EP00/13119

(51) Int. Cl. H04L 12/66

(52) U.S. Cl. 370/352

(57) ABSTRACT

A method and a system for using IETF ENUM for provisioning services to terminals in a communication network system are provided. According to the method, entries are provided in an ENUM serving means in correspondence with codes of terminal identifications. Then, the ENUM serving means may be queried by a terminal on the basis of an identification of the terminal, and returns records corresponding to a code of the terminal identification to the querying terminal.

### FIELD OF THE INVENTION

The present invention relates to providing a terminal with information, parameters and/or settings required to obtain services subscribed to the terminal.

### BACKGROUND OF THE INVENTION

Service provisioning means to provide a terminal which may be a new “blank” terminal, with the needed information, parameters and/or settings required to obtain services subscribed to the terminal. The needed information, parameters and/or settings may include for instance communication network parameters, such as GPRS (General Packet Radio Service) parameters or UMTS (Universal Mobile Telecommunication System) parameters, WAP (Wireless Application Protocol) parameters comprising a WAP Gateway address, a URL (Uniform Resource Locator) for Setup, a Home page and Favorites, WWW (World Wide Web) parameters comprising an HTTP (Hyper Text Transfer Protocol) Proxy address, SMTP/POP3 addresses, a URL for Setup, a Home page and Favorites, Public keys, IPv4, IPv6 and a Default Classmark for multi-classmark devices.

Service provisioning of terminals can be done either manually by the user who enters the parameters into the terminal, or somehow automated. There are several possibilities to provide the terminal with the needed information, parameters or settings, e.g. the terminal contacts a dedicated service provisioning server. For example, for WAP service provisioning, a user sends an SMS (Short Message Service) to a predefined number “400” with the content “WAP”, for example, and gets the WAP parameters pushed via SMS.

Having the user input data into the terminal risks human error. Human errors are less probable by using an automatic system. However, conventionally, a plurality of automatic systems has to be used to provide the terminal with all the information, parameters and settings required for the terminal to contact dedicated services on the respective service provisioning servers.

### SUMMARY OF THE INVENTION

It is therefore an object of the present invention to provide a single method and system for provisioning services in an improved manner.

According to an aspect of the present invention, this object is achieved by a method of using IETF ENUM for provisioning services to terminals in a communication network system, said method comprising the steps of:

providing entries in an ENUM serving means in correspondence with codes of terminal identifications;

querying the ENUM serving means by a terminal on the basis of an identification of the terminal; and

returning records corresponding to a code of the terminal identification from the ENUM serving means to the querying terminal.

According to another aspect of the present invention, the above-mentioned object is achieved by a communication network system for using IETF ENUM for provisioning services to terminals in the system, said system comprising:

ENUM serving means having entries in correspondence with codes of terminal identifications;

wherein, when a terminal queries the ENUM serving means on the basis of an identification of the terminal, the ENUM serving means returns records corresponding to a code of the terminal identification to the querying terminal.

The terminal examines the records returned from the ENUM serving means and determines service data on the basis of the examined records. The service data may comprise information, parameters and/or settings for obtaining services on a service provisioning server by the terminal.

The system may further comprise formatting means for receiving the terminal identification of the querying terminal, for formatting the terminal identification to a corresponding terminal identification code, and for querying the ENUM serving means on the code.

The ENUM serving means may have entries for the full code of a terminal identification and/or for a part of the code of a terminal identification.

In addition, the ENUM serving means may have entries which are the same for a group of terminals.

The ENUM serving means may also have entries for a lookup on a further serving means.

A new blank terminal may perform the query of the ENUM serving means, and/or the query of the ENUM serving means may be performed every time a new session is activated. Moreover, the query may be performed for updating services, and/or for provisioning new services.

The terminal identification may be the MSISDN of the terminal or a user's name.

The information, parameters and/or settings may comprise communication network parameters such as GPRS parameters and UMTS parameters, WAP parameters, a WAP gateway address, a URL for Setup, a Home page, Favorites, Public keys, IPv4, IPv6, a Default Classmark for multi-classmark devices, software updates, applets, a network storage location, user preference list and firmware updates.

Moreover, the ENUM serving means may be implemented in a DNS server in a data network.

According to a further aspect of the present invention, the above-mentioned object may be achieved by an apparatus using IETF ENUM for provisioning services to terminals in a communication network system, said apparatus having entries in correspondence with codes of terminal identifications;

wherein, when a terminal queries said apparatus on the basis of an identification of the terminal, said apparatus returns records corresponding to a code of the terminal identification to the querying terminal.

According to a still further aspect of the present invention, the above-mentioned object may be achieved by a user terminal for communicating with a network system using IETF ENUM for provisioning services to terminals in the system,

wherein the user terminal is adapted to query an ENUM serving means having entries in correspondence with codes of terminal identifications, on the basis of an identification of the user terminal.

Moreover, the user terminal may examine records returned from the ENUM serving means upon the query, the records corresponding to a code of the terminal identification, and determine service data on the basis of the examined records.

According to the present invention, the information, parameters and settings enabling the terminal to obtain services on respective service provisioning servers are provisioned to the terminal by an ENUM serving means such as an ENUM DNS (ENUM Domain Name Server) with only the terminal identification such as the MSISDN (ISDN number for Mobile Subscriber) defined, and all the services are in use immediately as they are defined in the DNS. New functionalities and properties for “blank” terminals can be defined fast in a scaleable manner. In addition, services for users with different capabilities can be provided. The terminal only needs to know how to use the records returned from the DNS. Human errors are less probable by using the automatic system according to the present invention. Further advantages of the present invention are that ENUM is scalable, flexible and cheap to implement as it can use standard DNS servers.

### BRIEF DESCRIPTION OF THE DRAWINGS

FIG. 1 shows a schematic diagram of a service provisioning system according to the present invention.

FIG. 2 shows a flowchart of steps performed in the service provisioning system according to the present invention.

FIG. 3 shows a schematic diagram of a service provisioning system according to an embodiment of the present invention.

### DESCRIPTION OF THE PREFERRED EMBODIMENT

The idea of the present invention is to use IETF (Internet Engineering Task Force) ENUM for provisioning services to terminals in a communication network system. ENUM is an IETF standardized system for providing address translations between telephone numbers and URLs. It provides a system for starting different ways of communication with a device associated to the input phone number.

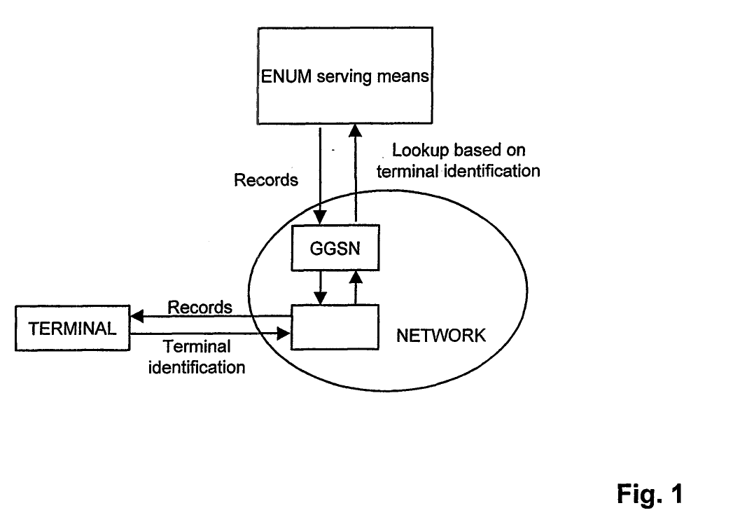

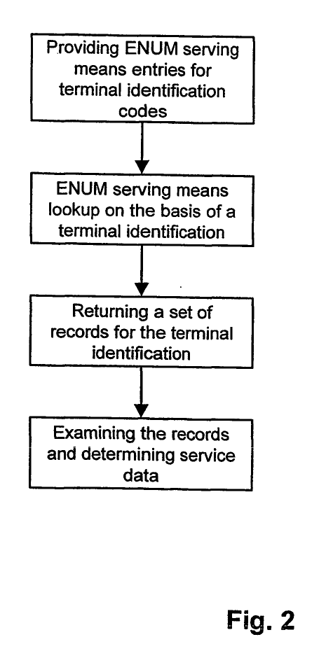

In the following, the concept of the present invention will be described with respect to FIGS. 1 and 2.

As shown in FIG. 1, a terminal which may be a new “blank” terminal queries an ENUM serving means on the basis of its terminal identification. The terminal identification may be the MSISDN of the terminal, a terminal user's name or anything that identifies the terminal or user. The terminal performs the query by sending its identification, e.g. by calling its own MSISDN, sending a message such as SMS or USSD including the identification. The terminal identification is directed through the network to which the terminal attaches and routed to the ENUM serving means. The terminal identification is formatted into an ENUM request format transparently on the way. The formatting can take place e.g. in the requesting terminal itself, or in any appropriate network element provided with translation capability. In this embodiment the formatting means is located in connection with the GGSN. The purpose of formatting is to format the terminal identification into a code understandable by the ENUM serving means. The code is sent to the ENUM serving means for a lookup on the code. The ENUM serving means returns a set of records for the queried code to the terminal via the formatting means and the network.

According to FIG. 2, in a first step, the ENUM serving means is provided with entries for terminal identification codes. These entries can be on different levels which will be described later. When an ENUM serving means lookup on the basis of a terminal identification is performed as indicated in the second step of FIG. 2, the ENUM serving means returns a set of records for the terminal identification according to the third step of FIG. 2. The terminal then examines the returned records and determines service data therefrom. The service data comprise the needed information, parameters and/or settings to obtain services subscribed to the terminal. The needed information, parameters and/or settings may include communication network related parameters such as GPRS parameters or UMTS parameters, WAP parameters comprising a WAP Gateway address, a URL for Setup, a Home page and Favorites, WWW parameters comprising an HTTP Proxy address, SMTP/POP3 addresses, a URL for Setup, a Home page and Favorites, Public keys, IPv4, IPv6, a Default Classmark for multi-classmark devices, software updates, applets, network storage location, a user preference list, firmware updates, etc.

According to the present invention, an ENUM serving means query is performed by the terminal and data are returned to the terminal. The query can be performed only once by a new “blank” terminal or every time a new session or context is activated or as often as needed also during a session or context, e.g. in order to update services or to provision new services.

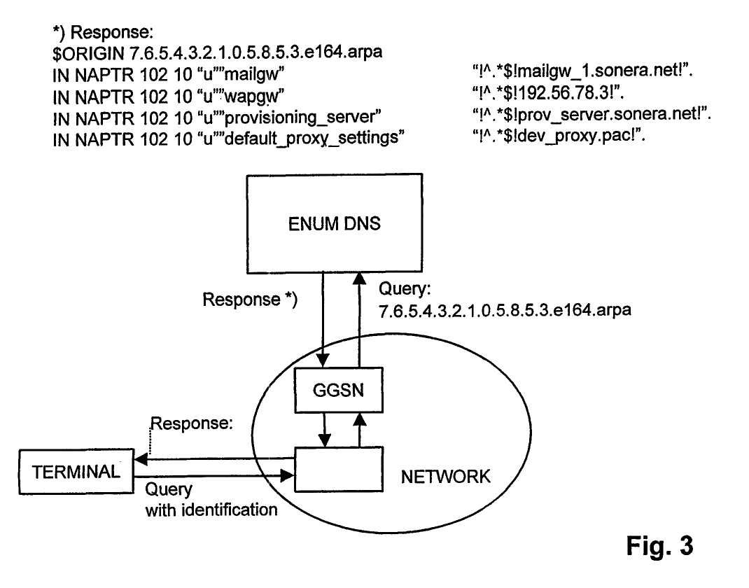

In the following, a preferred embodiment of the present invention will be described with respect to FIG. 3.

According to the preferred embodiment, the terminal identification is the MSISDN number of the terminal. The ENUM serving means is implemented in a DNS. When a user gets a blank terminal, i.e. a terminal without any information, parameters or settings, and a SIM (GSM Subscriber Identity Module) card with the MSISDN +358 50 123 45 67, for example, the blank terminal gets the needed parameters by making an ENUM query, as it is shown in FIG. 3. The E.164 number is formatted into the code 7.6.5.4.3.2.1.0.5.8.5.3.e164.arpa, and the ENUM DNS is queried on this code. The formatting of the query can take place in the terminal, or in any network element on the way which is provided with the capability of formatting. As an example of this, in the present embodiment the GGSN network element is provided with means for formatting. The query from the terminal can take place e.g. by making a call to the MS's own MSISDN, or by sending a message to the network. As a response on the query, the ENUM DNS returns the following record for the code 7.6.5.4.3.2.1.0.5.8.5.3.e164.arpa:

$ORIGIN 7.6.5.4.3.2.1.0.5.8.5.3.e164.arpa

| | |
|---|---|
| IN NAPTR 102 10 “u”“mailgw” | “\|\hat{ }.*$!mailgw_1.sonera.net!”. |
| IN NAPTR 102 10 “u”“wapgw” | “\|\hat{ }.*$!192.56.78.31!”. |
| IN NAPTR 102 10 | “\|\hat{ }.*$!prov_server.sonera.net!”. |
| “u”“provisioning server” | |
| IN NAPTR 102 10 | “\|\hat{ }.*$!dev_proxy.pac!”. |
| “u”“default_{— proxy settings”} | |

The DNS entries can also be on different levels. This means that there can be DNS entries which are the same for all users of one operator's network, e.g. the WAP Gateway, represented by the following entry in the DNS:

| | |
|---|---|
| $ORIGIN 5.8.5.3.e164.arpa | |
| IN NAPTR 102 10 “u” “wapgw” | “!\hat{ }.*$!192.56.78 3!”. |

Also, the DNS can be used for loadsharing. According to the example of the WAP Gateway, the DNS entry becomes:

| | |
|---|---|
| $ORIGIN 5.8.5.3.e164.arpa | |
| IN NAPTR 102 10 “U” “wapgw” | “!\hat{ }.*$!wapgw.sonera.com”. |

A further lookup on wapgw.sonera.com returns:

| ;; | Pref Weight Port Target | | |
|---|---|---|---|
| | wapgw.sonera.com | IN SRV0 0 | 1000 glc1.nokia.com |
| | | IN SRV0 0 | 1000 192.56.78.0 |
| | | IN SRV0 0 | 1000 192.56.78.1 |
| | | IN SRV0 0 | 1000 192.56.78.2 |

Moreover, there can be entries in the DNS for a group of users with the same number range (like +358 50 77X XXXX, e.g. for all Nokia employees) of a network operator. Then, the entry of the mail gateway, for example, is:

| | |
|---|---|
| $ORIGIN 7.7.0.5.8.5.3.e164.arpa | |
| IN NAPTR 102 10 | “\|\hat{ }.*$!mailgw_nokia.nokia.com!”. |
| “u” “mailgw_nokia” | |

Furthermore, in case of load sharing in e.g. services or resources based on a number range, e.g. there may be entries of different MMS relays for number range +358 50 5XX XXXX →MMS relay 1, and number range +358 50 6XX XXXX →MMS relay 2:

$ORIGIN 5.0.5.8.5.3.e164.arpa
IN NAPTR 102 10 “u” “mmsservice+E2U”

“!\hat{ }.*$!smtp:0407499122@mmmsrelay_1.sonera.net”

and
$ORIGIN 6.0.5.8.5.3.e164.arpa
IN NAPTR 102 10 “U” “mmsservice+E2U”

“!\hat{ }.*$!smtp:0407499122@mmmsrelay_2.sonera.net”

In addition, there can be DNS entries for a single MSISDN of a network operator, e.g. the SIP URL, tel, email address, and the MMS relay entry becomes:

| | |
|---|---|
| $ORIGIN 2.2.1.9.9.4.7.0.4.8.5.3.e164.arpa | |
| IN NAPTR 102 10“u”“sip+E2U” | “\|\hat{ }.*$!sip:john.loughney@sonera.net!”. |
| IN NAPTR 102 10“u”“mailto+E2U” | “\|\hat{ }.*$!mailto:0501234567@sonera_messi.net!”. |
| IN NAPTR 102 10“u”“tel+E2U” | “\|\hat{ }.*$!tel:+358407499122!”. |

As can be seen form the foregoing, using ENUM for service provisioning yields a scaleable and flexible system and method which is cheap to implement and reduces the change of human errors.

While the invention has been described with reference to a preferred embodiment, the description is illustrative of the invention and is not to be construed as limiting the invention. Various modifications and applications may occur to those skilled in the art without departing from the true spirit and scope of the invention as defined by the appended claims.

1. A method of using IETF ENUM for provisioning services to terminals in a communication network system, said method comprising the steps of:
providing entries in an ENUM serving means in correspondence with codes of terminal identifications;
querying the ENUM serving means by a terminal on the basis of an identification of the terminal; and
returning records corresponding to a code of the terminal identification from the ENUM serving means to the querying terminal.

2. A method according to claim 1, comprising the further step of:
examining the records returned from the ENUM serving means by the terminal and determining service data on the basis of the examined records.

3. A method according to claim 2, wherein the service data comprise information, parameters and/or settings for obtaining services on a service provisioning server by the terminal.

4. A method according to claim 1, wherein the querying step comprises the step of:
formatting the terminal identification to a corresponding terminal identification code and querying the ENUM serving means on the code.

5. A method according to claim 1, wherein the ENUM serving means is provided with entries for the full code of a terminal identification.

6. A method according to claim 1, wherein the ENUM serving means is provided with entries for a part of the code of a terminal identification.

7. A method according to claim 1, wherein the ENUM serving means is provided with entries which are the same for a group of terminals.

8. A method according to claim 1, wherein the ENUM serving means is provided with entries for a lookup on a further serving means.

9. A method according to claim 1, wherein the querying step is performed by a new blank terminal.

10. A method according to claim 1, wherein the querying step is performed every time a new session is activated.

11. A method according to claim 1, wherein the querying step is performed for updating services.

12. A method according to claim 1, wherein the querying step is performed for provisioning new services.

13. A method according to claim 1, wherein the terminal identification is the MSISDN of the terminal.

14. A method according to claim 1, wherein the terminal identification is a user's name.

15. A method according to claim 3, wherein the information, parameters and/or settings comprise communication network parameters, WAP parameters, a WAP gateway address, a URL for Setup, a Home page, Favorites, Public keys, IPv4, IPv6, a Default Classmark for multi-classmark devices, software updates, applets, a network storage location, user preference list and firmware updates.

16. A method according to claim 1, wherein the ENUM serving means is implemented in a DNS server in a data network.

17. A communication network system for using IETF ENUM for provisioning services to terminals in the system, said system comprising:
ENUM serving means having entries in correspondence with codes of terminal identifications;
wherein, when a terminal queries the ENUM serving means on the basis of an identification of the terminal, the ENUM serving means returns records corresponding to a code of the terminal identification to the querying terminal.

18. A system according to claim 17, wherein the terminal examines the records returned from the ENUM serving means and determines service data on the basis of the examined records.

19. A system according to claim 18, wherein the service data comprise information, parameters and/or settings for obtaining services on a service provisioning server by the terminal.

20. A system according to claim 17, further comprising:
formatting means for receiving the terminal identification of the querying terminal, for formatting the terminal identification to a corresponding terminal identification code, and for querying the ENUM serving means on the code.

21. A system according to claim 17, wherein the ENUM serving means has entries for the full code of a terminal identification.

22. A system according to claim 17, wherein the ENUM serving means has entries for a part of the code of a terminal identification.

23. A system according to claim 17, wherein the ENUM serving means has entries which are the same for a group of terminals.

24. A system according to claim 17, wherein the ENUM serving means has entries for a lookup on a further serving means.

25. A system according to claim 17, wherein a new blank terminal performs the query of the ENUM serving means.

26. A system according to claim 17, wherein a terminal performs the query of the ENUM serving means every time a new session is activated.

27. A system according to claim 17, wherein a terminal performs the query of the ENUM serving means for updating services.

28. A system according to claim 17, wherein a terminal performs the query of the ENUM serving means for provisioning new services.

29. A system according to claim 17, wherein the terminal identification is the MSISDN of the terminal.

30. A system according to claim 17, wherein the terminal identification is a user's name.

31. A system according to claim 19, wherein the information, parameters and/or settings comprise communication network parameters, WAP parameters, a WAP gateway address, a URL for Setup, a Home page, Favorites, Public keys, IPv4, IPv6, a Default Classmark for multi-classmark devices, software updates, applets, a network storage location, user preference list and firmware updates.

32. A system according to claim 17, wherein the ENUM serving means is implemented in a DNS server in a data network.

33. An apparatus using IETF ENUM for provisioning services to terminals in a communication network system, said apparatus having entries in correspondence with codes of terminal identifications;
wherein, when a terminal queries said apparatus on the basis of an identification of the terminal, said apparatus returns records corresponding to a code of the terminal identification to the querying terminal.

34. An apparatus according to claim 33, wherein said apparatus has entries for the full code of a terminal identification.

35. An apparatus according to claim 33, wherein said apparatus has entries for a part of the code of a terminal identification.

36. An apparatus according to claim 33, wherein said apparatus has entries which are the same for a group of terminals.

37. An apparatus according to claim 33, wherein said apparatus has entries for a lookup on a further serving means.

38. An apparatus according to claim 33, wherein the terminal identification is the MSISDN of the terminal.

39. An apparatus according to claim 33, wherein the terminal identification is a user's name.

40. An apparatus according to claim 33, wherein said apparatus is implemented in a DNS server in a data network.

41. A user terminal for communicating with a network system using IETF ENUM for provisioning services to terminals in the system,
wherein said user terminal is adapted to query an ENUM serving means ha ng entries in correspondence with codes of terminal identifications, on the basis of an identification of said user terminal.

42. A user terminal according to claim 41, wherein said user terminal is adapted to examine records returned from the ENUM serving means upon the query, the records corresponding to a code of the terminal identification, and to determine service data on the basis of the examined records.
